(19) United States
(12) Patent Application Publication
(10) Pub. No.: US 2025/0071857 A1
(43) Pub. Date: Feb. 27, 2025

(54) METHOD AND APPARATUS FOR RADIO LINK MONITORING IN WIRELESS COMMUNICATION SYSTEM

(71) Applicant: Samsung Electronics Co., Ltd., Gyeonggi-do (KR)

(72) Inventors: Youngbum KIM, Gyeonggi-do (KR); Taehan BAE, Gyeonggi-do (KR); Junyung YI, Gyeonggi-do (KR)

(21) Appl. No.: 18/815,039

(22) Filed: Aug. 26, 2024

(30) Foreign Application Priority Data
Aug. 25, 2023 (KR) 10-2023-0111681

(51) Int. Cl. H04W 76/28; H04W 52/02

(52) U.S. Cl. CPC H04W 76/28; H04W 52/0235

(57) ABSTRACT

The disclosure relates to a 5G or 6G communication system for supporting higher data transmission rates. A method performed by a UE in a communication system includes transmitting, to a base station, capability information including a capability to support an energy saving mode of the base station, the energy saving mode of the base station being based on cell DTX, receiving, from the base station, information associated with a measurement for the energy saving mode of the base station, identifying that the base station operates according to the energy saving mode, and receiving, from the base station, a reference signal for measurement based on the information.

### CROSS-REFERENCE TO RELATED APPLICATION(S)

This application is based on and claims priority under 35 U.S.C. § 119 to Korean Patent Application No. 10-2023-0111681, filed on Aug. 25, 2023, in the Korean Intellectual Property Office, the disclosure of which is incorporated herein by reference in its entirety.

### BACKGROUND

### 1. Field

The disclosure relates generally to a communication method of a wireless communication system and, more particularly, to a method and apparatus for radio link monitoring and energy savings in a wireless communication system.

### 2. Description of Related Art

Fifth generation (5G) mobile communication technology defines a wide frequency band to enable fast transmission speed and new services, and can be implemented not only in a sub-6 gigahertz (GHz) frequency band such as 3.5 GHz but also in an ultra-high frequency band (above 6 GHZ) referred to as millimeter wave (mmWave) such as 28 GHz or 39 GHz. In addition, sixth generation (6G) mobile communication technology referred to as a beyond 5G system is being considered for implementation in a terahertz (THz) band such as 95 GHz to 3 THz to achieve a transmission speed that is 50 times faster and ultra-low latency that is reduced to 1/10 compared with 5G mobile communication technology.

Since the beginning of 5G mobile communication technology development, to meet service support and performance requirements for enhanced mobile broadband (eMBB), ultra-reliable and low-latency communication (URLLC), and massive machine-type communications (mMTC), standardization has been performed regarding beamforming for mitigating the pathloss of radio waves and increasing the propagation distance thereof in the mm Wave band, massive multiple input multiple output (MIMO), support of various numerology for efficient use of ultra-high frequency resources (e.g., operating multiple subcarrier spacings), dynamic operations on slot formats, initial access schemes to support multi-beam transmission and broadband, definition and operation of bandwidth part (BWP), new channel coding schemes such as low density parity check (LDPC) codes for large-capacity data transmission and polar codes for reliable transmission of control information, layer 2 (L2) pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as vehicle-to-everything (V2X) that aims to enable a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIOT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access channel (2-step RACH) for NR that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, the ever-increasing number of connected devices will be connected to the communication networks. Thus, it is expected that enhancement in function and performance of the 5G mobile communication system and the integrated operation of the connected devices will be required. To this end, new research will be conducted regarding 5G performance improvement and complexity reduction, artificial intelligence (AI) service support, metaverse service support, and drone communication by utilizing extended reality (XR) for efficiently supporting augmented reality (AR), virtual reality (VR), and mixed reality (MR), AI, and machine learning (ML).

Such advancement of 5G mobile communication systems will be the basis for the development of technologies such as new waveforms for ensuring coverage in the THz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes AI from the design stage and internalizes end-to-end AI support functions to realize system optimization, and next-generation distributed computing that realizes services having complexity that exceeds the limit of terminal computing capabilities by utilizing ultra-high-performance communication and computing resources.

To handle the recent proliferation in mobile data traffic, the initial standard for the 5G system or NR access technology, as the next-generation communication system after long term evolution (LTE) or evolved universal terrestrial radio access (E-UTRA) and LTE-advanced (LTE-A) or E-UTRA evolution, has been completed. While existing mobile communication systems have focused on regular voice/data communication, the 5G systems aim to satisfy a variety of services and requirements such as high-speed eMBB services for improving existing voice/data communication, URLLC) services, and mMTC services.

While the system transmission bandwidth per single carrier of existing LTE and LTE-A is limited to a maximum of 20 MHz, the 5G system mainly aims to provide ultra-high-speed data services reaching several gigabits per second (Gbps) by utilizing a much wider ultra-wide bandwidth. Hence, the 5G system is considering ultra-high frequency bands ranging from several GHz to up to 100 GHz, where it is relatively easy to secure ultra-wide bandwidth frequencies as candidate frequencies. Additionally, through frequency reassignment or allocation, it is possible to secure wide bandwidth frequencies for the 5G system among the frequency bands belonging to a range from hundreds of megahertz (MHz) to several GHz used in existing mobile communication systems.

In the ultra-high frequency band, pathloss of the radio wave is increased in proportion to the frequency band, and thus the coverage of the mobile communication system is decreased.

To overcome this drawback, beamforming technology is applied to increase the arrival distance of the radio wave by using multiple antennas to focus the radiant energy of radio waves to a specific destination point. That is, the beam width of the signal to which the beamforming technology is applied becomes relatively narrow, and radiant energy is concentrated within the narrowed beam width, thereby increasing the arrival distance of the radio wave. The beamforming technology may be applied respectively to the transmitting end and the receiving end. In addition to increasing the coverage, the beamforming technology has an effect of reducing interference in a region other than the beamforming direction. For the beamforming technology to operate properly, accurate transmit/receive beam measurement and feedback methods are required. The beamforming technology may be applied to control or data channels that correspond one-to-one between a given UE and base station. To increase the coverage, the beamforming technology may also be applied to control channels and data channels for transmitting common signals, such as a synchronization signal, physical broadcast channel (PBCH) or system information, from the base station to multiple UEs in the system. In the case of applying beamforming technology to a common signal, a beam sweeping technology, which transmits a signal by changing the beam direction, may be additionally applied to ensure that the common signal can reach UEs located at arbitrary positions within the cell.

As another requirement for the 5G system, an ultra-low latency service with a transmission delay of approximately 1 ms between the transmitting and receiving ends is required. To reduce transmission delay, there is a need in the art to design a frame structure based on a shorter transmission time interval (TTI) compared to LTE and LTE-A.

With the advancement of mobile communication systems as described above, various services can be provided. Accordingly, there is a need in the art for a method for effectively providing these services. In particular, there is a need in the art for a method and apparatus for energy saving in a wireless communication system.

### SUMMARY

The disclosure has been made to address at least the above-mentioned problems and/or disadvantages and to provide at least the advantages described below.

Accordingly, an aspect of the disclosure is to provide an apparatus and method that can prevent excessive energy consumption of a base station and achieve high energy efficiency in a mobile communication system.

In accordance with an aspect of the disclosure, a method performed by a UE in a communication system includes transmitting, to a base station, capability information including a capability to support an energy saving mode of the base station, the energy saving mode of the base station being based on cell discontinuous transmission (DTX), receiving, from the base station, information associated with a measurement for the energy saving mode of the base station, identifying that the base station operates according to the energy saving mode, and receiving, from the base station, a reference signal for measurement based on the information.

In accordance with an aspect of the disclosure, a method performed by a base station operating according to an energy saving mode in a communication system includes receiving, from a UE, capability information including a capability to support the energy saving mode of the base station, the energy saving mode of the base station being based on cell DTX, transmitting, to the UE, information associated with a measurement for the energy saving mode of the base station, and transmitting, to the UE, a reference signal for measurement according to the information.

In accordance with an aspect of the disclosure, a UE in a communication system includes a transceiver, and at least one processor configured to: transmit, to a base station, capability information including a capability to support an energy saving mode of the base station, the energy saving mode of the base station being based on cell DTX, receive, from the base station, information associated with a measurement for the energy saving mode of the base station, identify that the base station operates according to the energy saving mode, and receive, from the base station, a reference signal for measurement based on the information.

In accordance with an aspect of the disclosure, a base station operating according to an energy saving mode in a communication system includes a transceiver, and at least one processor configured to: receive, from a UE, capability information including a capability to support the energy saving mode of the base station, the energy saving mode of the base station being based on cell DTX, transmit, to the UE, information associated with a measurement for the energy saving mode of the base station, and transmit, to the UE, a reference signal for measurement according to the information.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates the basic structure of a time-frequency resource domain of a 5G system according to an embodiment;

FIG. 2 illustrates the structure of mapping synchronization signals to the time domain and beam sweeping operation according to an embodiment;

FIG. 3 illustrates a random access procedure according to an embodiment;

FIG. 4 illustrates a procedure in which a UE reports UE capability information to a base station according to an embodiment;

FIG. 5 illustrates an example of cell DTX operation according to an embodiment;

FIG. 6 illustrates an example of cell DTX operation and reference signal transmission according to an embodiment;

FIG. 7 illustrates an example of a method for measuring a reference signal in a UE during cell DTX operation according to an embodiment;

FIG. 8 illustrates another example of a method for measuring a reference signal in a UE during cell DTX operation according to an embodiment;

FIG. 9 illustrates a UE procedure according to an embodiment;

FIG. 10 illustrates a base station procedure according to an embodiment;

FIG. 11 illustrates the transceiver of a UE according to an embodiment;

FIG. 12 illustrates the structure of a UE according to an embodiment; and

FIG. 13 illustrates the structure of a base station according to an embodiment.

### DETAILED DESCRIPTION

Embodiments of the disclosure will be described in detail referring to the accompanying drawings. A detailed description of known functions or configurations incorporated herein will be omitted for the sake of clarity and conciseness.

For the same reasons, some elements may be exaggerated or schematically shown. The size of each element does not necessarily reflect the actual size of the element. The same reference numeral may be used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto.

The terms described below are defined in consideration of their functions in the disclosure, and these may vary depending on the intention of the user, the operator, or the custom. Hence, their meanings should be determined based on the overall contents of this specification.

Herein, the elements included in the disclosure are expressed in a singular or plural form according to the proposed specific embodiment. However, the singular or plural expression is appropriately selected for ease of description according to the presented situation, and the disclosure is not limited to a single element or plural elements. Those elements described in a plural form may be configured as a single element, and those elements described in a singular form may be configured as plural elements.

The same reference symbols are used throughout the specification to refer to the same parts.

The terms used in the following description for identifying an access node and for indicating a network entity, a message, an interface between network entities, and various identification information are provided for ease of description. Accordingly, the disclosure is not limited by the terms used herein and other terms referring to objects having an equivalent technical meaning may be used.

In the following description, a physical channel or a signal may be used interchangeably with data or a control signal. For example, a physical downlink shared channel (PDSCH) refers to a physical channel through which data is transmitted, but the PDSCH may also be used to refer to data. That is, an expression “transmitting a physical channel” may be interpreted as being equivalent to an expression “transmitting data or a signal through a physical channel”.

In the disclosure, higher signaling indicates a method of transmitting a signal from the base station to the UE by using a downlink data channel of the physical layer, or from the UE to the base station by using an uplink data channel of the physical layer. Higher signaling may be understood as radio resource control (RRC) signaling or medium access control (MAC) control element (CE).

For convenience of description, the disclosure uses terms and names defined in the 5G NR mobile communication standard specification. However, the disclosure is not limited by the above terms and names and may be equally applied to systems complying with other standards.

In the following description, the base station (BS), as a main agent that allocates resources to a terminal, may be at least one of gNode B, gNB, eNode B, eNB, Node B, radio access unit, base station controller, or node on a network. The terminal may include, but not limited to, a UE, a mobile station (MS), a cellular phone, a smartphone, a computer, an IoT device, a sensor, or a multimedia system capable of performing a communication function.

The TTI is a basic time unit for performing scheduling, and the TTI of the existing LTE and LTE-A system is 1 millisecond (ms) corresponding to the length of one subframe. For example, in the 5G system, a short TTI to satisfy the requirements for ultra-low delay services may be set to 0.5 ms, 0.25 ms, or 0.125 ms, which is shorter than that of existing LTE and LTE-A systems.

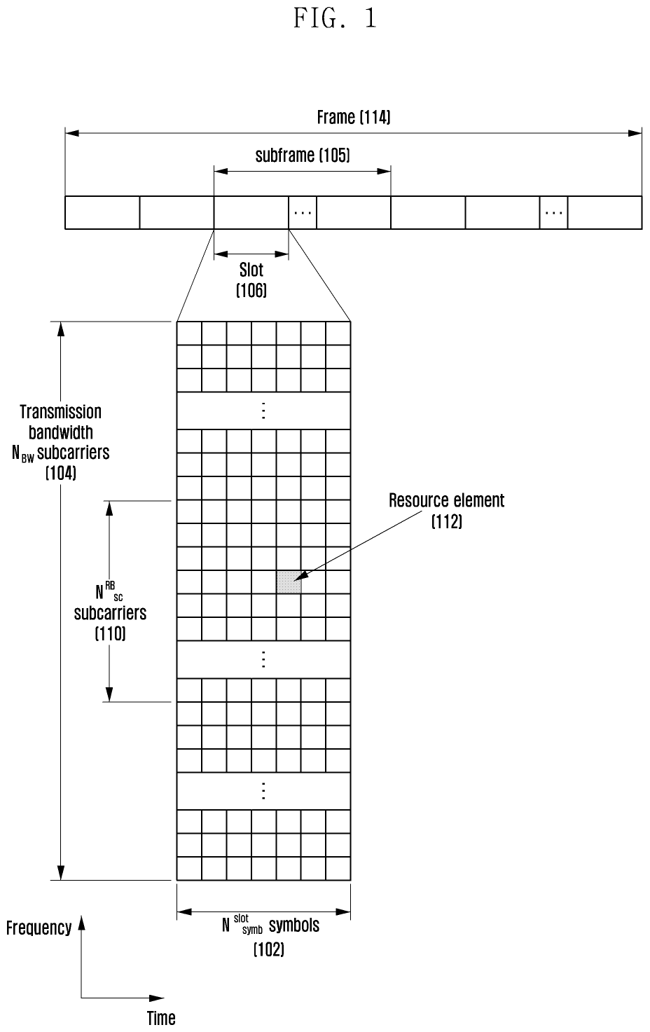

FIG. 1 illustrates the basic structure of a time-frequency resource domain of a 5G system according to an embodiment. That is, FIG. 1 shows the basic structure of a time-frequency resource domain, which is a radio resource region where data or control channels of the 5G system are transmitted.

Referring to FIG. 1, the horizontal axis represents the time domain, and the vertical axis represents the frequency domain. The minimum transmission unit in the time domain of the 5G system is orthogonal frequency division multiplexing (OFDM) symbols, N_{symb}^{slot} symbols 102 may collectively constitute one slot 106, and Nₛₗₒₜ^{subframe} may collectively constitute slot one subframe 105. The length of the subframe 105 is 1.0 ms, and 10 subframes may collectively constitute one frame 114 of 10 ms. The minimum transmission unit in the frequency domain is a subcarrier, and the bandwidth of the entire system transmission band may be composed of a total of N_{BW} subcarriers 104.

In the time-frequency domain, the basic unit of a resource is a resource element (RE) 112, and it may be indicated by an OFDM symbol index and a subcarrier index. A resource block (RB) or physical resource block (PRB) may be defined as N_{sc}^{RB} consecutive subcarriers 110 in the frequency domain. In the 5G system, N_{sc}^{RB}=12, and the data rate may increase in proportion to the number of RBs scheduled for the UE.

In the 5G system, the base station may map data on an RB basis and may generally perform scheduling on the RBs constituting one slot for a given UE. That is, the basic time unit for scheduling in the 5G system may be a slot, and the basic frequency unit for scheduling may be an RB.

The number of OFDM symbols N_{symb}^{slot} may be determined according to the length of a cyclic prefix (CP) that is added for each symbol to prevent inter-symbol interference. For example, if a normal CP is applied, N_{symb}^{slot}=14, whereas if an extended CP is applied, N_{symb}^{slot} 5=12. Compared to the normal CP, the extended CP is applied to a system where the radio wave transmission distance is relatively long, so that orthogonality between symbols is maintained. In the case of a normal CP, the ratio between the CP length and the symbol length is maintained at a constant value, so that the overhead due to the CP can be maintained constant regardless of the subcarrier spacing. That is, if the subcarrier spacing is small, the symbol length increases, and the CP length may also increase accordingly. Conversely, if the subcarrier spacing is large, the symbol length becomes short, and the CP length may decrease accordingly. The symbol length and CP length may be inversely proportional to the subcarrier spacing.

In the 5G system, various frame structures may be supported by adjusting the subcarrier spacing to satisfy various services and requirements. As examples:

From a perspective of the operating frequency band, the larger the subcarrier spacing, the more advantageous it is for phase noise recovery in the high frequency band.

From a perspective of the transmission time, if the subcarrier spacing is large, the symbol length in the time domain is shortened. As a result, the slot length is shortened, which is advantageous for supporting ultra-low latency services such as URLLC.

From a perspective of the cell size, the longer the CP length, the more a larger cell can be supported, so the smaller the subcarrier spacing, the more a relatively large cell can be supported. In mobile communication, the cell is a concept that refers to an area covered by one base station.

The subcarrier spacing and CP length are essential information for OFDM transmission and reception, and smooth transmission and reception is possible only when the base station and the UE recognize the subcarrier spacing and CP length as common values. Table 1 below shows the relationship between subcarrier spacing configuration (μ), subcarrier spacing (Δf), and CP length supported by the 5G system.

TABLE 1

| μ | Δf = 2^{μ} · 15 [KHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows, in the case of normal CP, the number of symbols per slot (N_{symb}^{slot} the number of slots per frame (Nₛₗₒₜ^{frame,μ}), and the number of slots per subframe (Nₛₗₒₜ^{subframe,μ}) for each subcarrier spacing configuration (μ).

TABLE 2

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below shows, in the case of extended CP, the number of symbols per slot (N_{symb}^{slot}), the number of slots per frame (Nₛₗₒₜ^{frame,μ}), and the number of slots per subframe (Nₛₗₒₜ^{subframe,μ}) for each subcarrier spacing configuration (μ).

TABLE 3

| μ | N_{symb}^{slot} | Nₛₗₒₜ^{frame,μ} | Nₛₗₒₜ^{subframe,μ} |
|---|---|---|---|
| 2 | 12 | 40 | 4 |

It is expected that the 5G system will coexist with the existing LTE or/and LTE-A (LTE/LTE-A) system or will be operated in dual mode therewith. Thereby, the existing LTE/LTE-A system may provide stable system operation to the UE, and the 5G system may provide improved services to the UE. Hence, the frame structure of the 5G system needs to include at least the frame structure or essential parameter set (subcarrier spacing=15 kHz) of LTE/LTE-A.

For example, when comparing a frame structure with subcarrier spacing configuration μ=0 (hereinafter referred to as frame structure A) and a frame structure with subcarrier spacing configuration μ=1 (hereinafter referred to as frame structure B), frame structure B corresponds to when the subcarrier spacing and RB size are doubled, and the slot length and symbol length are reduced by half in comparison to frame structure A. In the case of frame structure B, two slots may constitute one subframe, and 20 subframes may constitute one frame.

If the frame structure of the 5G system is generalized, where the subcarrier spacing, CP length, and slot length belong to the essential parameter set, an integer multiple relationship may be established between the subcarrier spacing, CP length, and slot length of one frame structure and those of another frame structure, so that high scalability can be provided. To represent a reference time unit independent of the frame structure, a subframe with a fixed length of 1 ms may be defined.

The frame structure of the 5G system may be applied in correspondence to various scenarios. From a perspective of the cell size, the longer the CP length, the larger cell can be supported, so frame structure A can support relatively larger cells compared to frame structure B. From a perspective of the operating frequency band, the larger the subcarrier spacing, the more advantageous it is to recover phase noise in the high frequency band, so frame structure B can support a relatively higher operating frequency compared to frame structure A. From a service perspective, it is advantageous to have a shorter slot length, which is the basic time unit for scheduling, to support ultra-low-latency services such as URLLC, so frame structure B may be more suitable for URLLC services compared to frame structure A.

In an initial access stage in which a UE initially accesses the system, the UE may first set downlink time and frequency synchronization from a synchronization signal transmitted by the base station through cell search and obtain a cell identity (ID). Then, the UE may receive a PBCH by using the obtained cell ID and obtain a master information block (MIB) being essential system information from the PBCH. Additionally, the UE may receive a system information block (SIB) transmitted by the base station to obtain cell-common control information related to transmission and reception. The cell-common control information related to transmission and reception may include random access-related control information, paging-related control information, and common control information about various physical channels.

The synchronization signal may be a reference signal for cell search, and the subcarrier spacing may be applied for each frequency band in a manner suitable to the channel environment such as phase noise. In the case of a data channel or control channel, the subcarrier spacing may be applied differently according to the service type to support the above-described services.

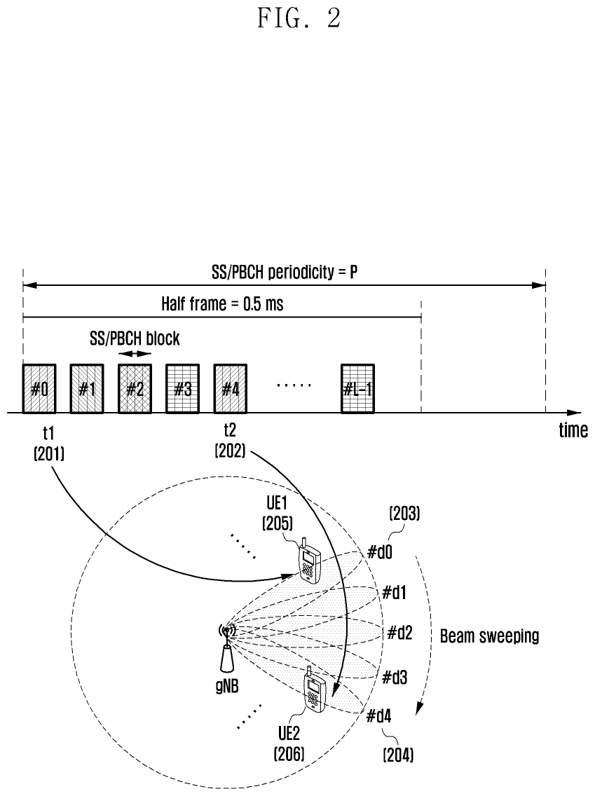

FIG. 2 illustrates the structure of mapping synchronization signals to the time domain and beam sweeping operation according to an embodiment.

For description, the following constituents may be defined.

A primary synchronization signal (PSS) serves as a reference for DL time/frequency synchronization and provides some information about the cell ID.

A secondary synchronization signal (SSS) serves as a reference for DL time/frequency synchronization and provides the remaining information about the cell ID. Additionally, it may serve as a reference signal for PBCH demodulation.

A PBCH provides an MIB, which is essential system information required for transmission and reception of data channels and control channels of the UE. The MIB may include control information about a search space indicating radio resource mapping information of a control channel, scheduling control information for a separate data channel transmitting system information, and information about the system frame number (SFN) being a frame-based index serving as a timing reference.

A synchronization signal/PBCH block or SSB (SS/PBCH block) is composed of N OFDM symbols and a combination of PSS, SSS, PBCH, or the like. In the case of a system where beam sweeping technology is applied, the SS/PBCH block is the minimum unit to which beam sweeping is applied. In a 5G system, the value of N may be 4. The base station may transmit up to L SS/PBCH blocks, and the L SS/PBCH blocks are mapped within a half frame (0.5 ms). Additionally, the L SS/PBCH blocks are periodically repeated with a specific periodicity P. The periodicity P may be notified to the UE by the base station through signaling. If there is no separate signaling for the periodicity P, the UE applies a pre-agreed default value. Each SS/PBCH block may have an SS/PBCH block index ranging from 0 to L-1, and the UE may identify the SS/PBCH block index through SS/PBCH detection.

Referring to FIG. 2, beam sweeping is applied over time on a SS/PBCH block basis. In the example of FIG. 2, UE 1 (205) uses a beam radiated in direction #d0 (203) by beamforming applied to SS/PBCH block #0 at time t1 (201) to receive a SS/PBCH block. The UE 2 (206) uses a beam radiated in direction #d4 (204) by beamforming applied to SS/PBCH block #4 at time t2 (202) to receive a SS/PBCH block. A UE may obtain an optimal synchronization signal through a beam radiated by the base station from where the UE is located. For example, it may be difficult for UE 1 (205) to obtain time/frequency synchronization and essential system information from a SS/PBCH block delivered through a beam radiated in direction #d4, which is far from the position of UE 1.

In addition to the initial access procedure, the UE may also receive an SS/PBCH block to determine whether the radio link quality of the current cell is maintained on or above a specific level. Additionally, in a handover procedure in which the UE moves from the current cell to a neighbor cell, the UE may receive an SS/PBCH block of the neighbor cell to determine the radio link quality of the neighbor cell and obtain time/frequency synchronization of the neighbor cell.

After the UE obtains the MIB and system information from the base station through the initial access procedure, the UE may perform a random access procedure to switch the link with the base station to the connected state (or, RRC_CONNECTED state). When the random access procedure is completed, the UE switches to the connected state, and one-to-one communication is possible between the base station and the UE.

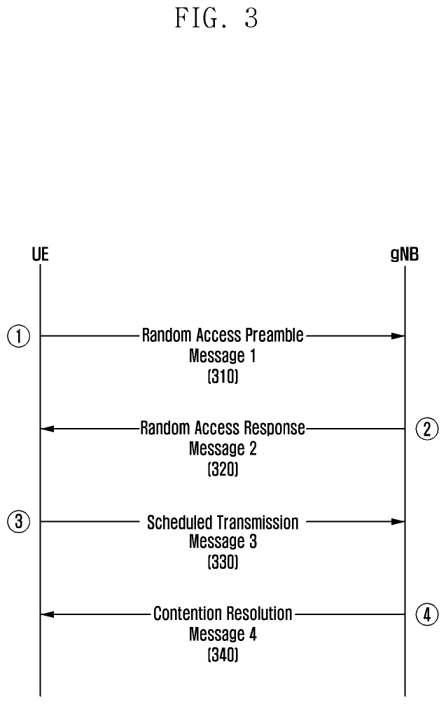

FIG. 3 illustrates a random access procedure according to an embodiment.

Referring to FIG. 3, in step 310 of the random access procedure, the UE transmits a random access preamble to the base station. The random access preamble, which is the first message transmitted by the UE in the random access procedure, may be referred to as message 1. Based on the random access preamble, the base station may measure a transmission delay value between the UE and the base station and achieve uplink synchronization. The UE may randomly select a random access preamble to be used from a random access preamble set given in advance by system information. Additionally, the initial transmission power for the random access preamble may be determined according to the pathloss between the base station and the UE measured by the UE. The UE may determine the transmit beam direction for the random access preamble based on the synchronization signal received from the base station and transmit the random access preamble.

In step 320, the base station transmits an uplink transmission timing control command to the UE based on a transmission delay value measured from the random access preamble received in step 310. Additionally, the base station may transmit an uplink resource and power control command to be used by the UE as scheduling information. The scheduling information may include control information about the uplink transmit beam of the UE.

If the UE fails to receive a random access response (RAR) or message 2 being scheduling information for message 3 from the base station within a specified time in step 320, it may perform the first step 310 again. If the first step 310 is performed again, the UE may transmit the random access preamble with a transmission power increased by a specific step (power ramping) to thereby increase the probability for the base station to receive the random access preamble.

In step 330, the UE transmits uplink data (message 3) including its UE ID to the base station by using the uplink resource allocated in step 320 over a physical uplink shared channel (PUSCH). The transmission timing of the uplink data channel for transmitting message 3 may follow the transmission timing control command received from the base station in step 320. Additionally, the transmission power of the uplink data channel for transmitting message 3 may be determined in consideration of the power control command received from the base station in step 320 and the power ramping value of the random access preamble. The uplink data channel for transmitting message 3 may refer to the first uplink data signal transmitted by the UE to the base station after UE's transmission of the random access preamble.

In step 340, upon determining that the UE has performed random access without colliding with other UEs, the base station transmits data (message 4) including the ID of the UE having transmitted the uplink data in step 330 to the corresponding UE. If the UE receives the signal transmitted by the base station in step 340, the UE may determine that the random access is successful. Then, the UE may transmit hybrid automatic repeat request acknowledgement (HARQ-ACK) information indicating successful or unsuccessful reception of message 4 to the base station over a physical uplink control channel (PUCCH).

If the data transmitted by the UE in step 330 collides with data of another UE and the base station fails to receive the data signal from the UE, the base station may discontinue transmitting data to the UE. As a result, if the UE fails to receive data transmitted from the base station in step 340 within a given time, the UE may determine that the random access procedure has failed and may return to step 310.

If the random access procedure is successfully completed, the UE switches to the connected state, and one-to-one communication is enabled between the base station and the UE. The base station may receive UE capability information from the UE in connected state and adjust scheduling in consideration of the UE capability information of the corresponding UE. Through the UE capability information, the UE may notify the base station of whether the UE supports a specific function, the maximum allowable value for the function supported by the UE, and the like. Hence, the UE capability information reported by each UE to the base station may have different values for individual UEs.

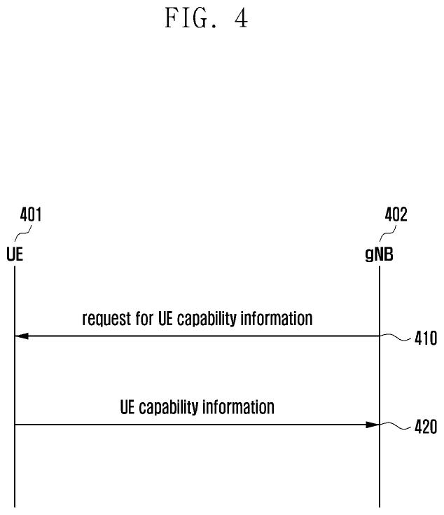

FIG. 4 illustrates a procedure in which the UE reports UE capability information to the base station according to an embodiment.

Referring to FIG. 4, in step 410, the base station 402 may transmit a request message for UE capability information to the UE 401. In response to the request for UE capability information from the base station, in step 420, the UE may transmit UE capability information to the base station.

For example, the UE may report UE capability information including at least a portion of the following control information to the base station as the above UE capability information.
Control information about the frequency bands supported by the UE
Control information about the channel bandwidth supported by the UE
Control information about the maximum modulation scheme supported by the UE
Control information about the maximum number of beams supported by the UE
Control information about the maximum number of layers supported by the UE
Control information about channel state information (CSI) reporting supported by the UE
Control information about whether frequency hopping is supported by the UE
Control information about bandwidths in the case of supporting carrier aggregation (CA)
Control information about whether cross carrier scheduling is supported in the case of supporting CA

In the 5G system, scheduling information for a PUSCH) or a PDSCH may be delivered from the base station to the UE via downlink control information (DCI). The UE may monitor a fallback DCI format and a non-fallback DCI format for the PUSCH or PDSCH. A fallback DCI format may include fixed fields predefined between the base station and the UE, and a non-fallback DCI format may include fields that may be configurable.

DCI may be transmitted over a physical downlink control channel (PDCCH), through a channel coding and modulation process. A cyclic redundancy check (CRC) may be attached to the payload of a DCI message, and may be scrambled with a radio network temporary identifier (RNTI) corresponding to the identity of the UE. Different RNTIs may be used according to the purpose of the DCI message, such as for UE-specific data transmission, a power control command, or a random access response. That is, the RNTI is not explicitly transmitted, but is transmitted by being included in the CRC calculation process. Upon receiving a DCI message transmitted over the PDCCH, the UE may perform a CRC check by using the assigned RNTI. If the CRC check result is correct, the UE may be aware that the corresponding message has been transmitted to the UE.

For example, DCI for scheduling a PDSCH for system information (SI) may be scrambled with an SI-RNTI. DCI for scheduling a PDSCH for a random access response (RAR) message may be scrambled with an RA-RNTI. DCI for scheduling a PDSCH for a paging message may be scrambled with a P-RNTI. DCI for notifying a slot format indicator (SFI) may be scrambled with an SFI-RNTI. DCI for notifying transmit power control (TPC) may be scrambled with a TPC-RNTI. DCI for scheduling UE-specific PDSCH or PUSCH may be scrambled with a cell RNTI (C-RNTI).

For the UE to be scheduled, the base station may apply specific DCI formats depending on whether DCI is scheduling information for a downlink assignment, scheduling information for an uplink grant, or for purposes other than data scheduling such as power control.

The base station may transmit downlink data to the UE through the PDSCH for downlink data transmission. Scheduling information such as specific mapping position of the PDSCH in the time-frequency domain, modulation scheme, HARQ-related control information, and power control information may be notified by the base station to the UE through DCI related to downlink data scheduling information among DCIs transmitted through the PDCCH.

The UE may transmit uplink data to the base station through the PUSCH for uplink data transmission. Scheduling information such as specific mapping position of the PUSCH in the time-frequency domain, modulation scheme, HARQ-related control information, and power control information may be notified by the base station to the UE through DCI related to uplink data scheduling information among DCIs transmitted through the PDCCH.

The time-frequency resource to which the PDCCH is mapped is referred to as a control resource set (CORESET). In the frequency domain, the CORESET may be configured on all or part of the frequency resources of the bandwidth supported by the UE. In the time domain, the CORESET may be configured on one or multiple OFDM symbols, and this may be defined as the CORESET length (or CORESET duration). The base station may configure one or multiple CORESETs to the UE through higher layer signaling (e.g., system information, MIB, or RRC signaling). Configuring a CORESET to the UE may mean providing information such as CORESET ID (identity), frequency position of the CORESET, and symbol length of the CORESET. The information provided by the base station to the UE to configure a CORESET may include at least some of the information included in Table 4 below.

TABLE 4
ControlResourceSet ::= SEQUENCE {

controlResourceSetId ControlResourceSetId,
frequencyDomainResources BIT STRING (SIZE (45)),

duration INTEGER (1..maxCoReSetDuration),

cce-REG-MappingType CHOICE {

interleaved SEQUENCE {

reg-BundleSize ENUMERATED {n2, n3, n6},

interleaverSize ENUMERATED {n2, n3, n6},
shiftIndex INTEGER(0..maxNrofPhysicalResourceBlocks-1)

OPTIONAL -- Need S

},
nonInterleaved NULL

},
precoderGranularity ENUMERATED {sameAsREG-bundle, allContiguousRBs},

tci-StatesPDCCH-ToAddList SEQUENCE(SIZE (1..maxNrofTCI-

StatesPDCCH)) OF TCI-StateId OPTIONAL, -- Cond NotSIB1-initialBWP

tci-StatesPDCCH-ToReleaseList SEQUENCE(SIZE (1..maxNrofTCI-StatesPDCCH))

OF TCI-StateId OPTIONAL, -- Cond NotSIB1-initialBWP

tci-PresentInDCI ENUMERATED {enabled} OPTIONAL, --

Need S

pdcch-DMRS-ScramblingID INTEGER (0..65535) OPTIONAL,

-- Need S
}

The CORESET may be composed of N_{RB}^{CORESET} in the frequency domain and may be composed of N_{symb}^{CORESET} ∈ {1,2,3} symbols in the time domain. The NR PDCCH may be composed of one or multiple control channel elements (CCEs). One CCE may be composed of 6 RE groups (REGs), and one REG may be defined as 1 RB during 1 OFDM symbol. In a CORESET, REGs may be indexed in a time-first manner starting at REG index 0 for the first OFDM symbol and the lowest-numbered RB in the CORESET.

An interleaved method and a non-interleaved method may be supported in a PDCCH transmission method. The base station may configure the UE with whether to use interleaved or non-interleaved transmission for each CORESET through higher layer signaling. Interleaving may be performed on a REG bundle basis. A REG bundle may be defined as a set of one or multiple REGs. The UE may determine the CCE-to-REG mapping scheme in the corresponding CORESET in a manner as shown in Table 5 below based on the interleaved or non-interleaved transmission configured by the base station.

TABLE 5
The CCE-to-REG mapping for a control-resource set can be interleaved or non-
interleaved and is described by REG bundles:

| | |
|---|---|
| - | REG bundle i is defined as REGs {iL, iL + 1, . . . , iL + L − 1} where L is the REG |
| | bundle size, i = 0,1, ... , N_{REG}^{CORESET}/L − 1, and N_{REG}^{CORESET} = N_{RB}^{CORESET}N_{symb}^{CORESET} |
| | is the number of REGs in the CORESET |
| - | CCE j consists of REG bundles {f(6j/L), f(6j/L+1), . . . , f(6j/L + 6/L − 1)} |
| | where f(·)is an interleaver |

For non-interleaved CCE-to-REG mapping, L = 6 and f(x) = x.
For interleaved CCE-to-REG mapping, L ∈ {2,6}for N_{symb}^{CORESET} = 1 and L ∈
{N_{symb}^{CORESET}, 6} for N_{symb}^{CORESET} ∈ {2,3}. The interleaver is defined by

f(x) = (rC + c + n_{shift}) mod (N_{REG}^{CORESET}/L)

```
    x = cR + r
  r = 0,1, ... , R − 1
  c = 0,1, ... , C − 1
C = N_{REG}^{CORESET}/LR)
```

where R ∈ {2,3,6}.

The base station may notify, via signaling, the UE of configuration information such as symbols to which the PDCCH is mapped in a slot, a transmission periodicity, or the like.

The search space for the PDCCH may be described as follows. The number of CCEs required to transmit a PDCCH may be 1, 2, 4, 8, or 16 depending on the aggregation level (AL), and a different number of CCEs may be used for link adaptation of a downlink control channel. For example, when AL=L, one downlink control channel may be transmitted by using L CCEs. The UE performs blind decoding for detecting a signal when it does not know information about the downlink control channel, and a search space representing a set of CCEs may be defined accordingly. The search space is a set of downlink control channel candidates composed of CCEs that the UE should attempt to decode at a given aggregation level. Since there are various aggregation levels that make bundles of 1, 2, 4, 8 and 16 CCEs, respectively, the UE may have multiple search spaces. A search space set may be defined as a set of search spaces at all configured aggregation levels.

The search spaces may be classified into a common search space (CSS) and a UE-specific search space (USS). A specific group of UEs or all UEs may examine the common search space of a PDCCH to receive cell-common control information such as dynamic scheduling of system information or a paging message. For example, the UE may receive scheduling assignment information of the PDSCH for receiving system information by examining the common search space of the PDCCH. Since a specific group of UEs or all UEs need to receive the PDCCH, the common search space may be defined as a set of pre-agreed CCEs. The UE may receive scheduling assignment information for a UE-specific PDSCH or PUSCH by examining the UE-specific search space of a PDCCH. The UE-specific search space may be defined in a UE-specific manner as a function of the UE ID and various system parameters.

The base station may configure configuration information about the search space of the PDCCH to the UE through higher layer signaling (e.g., SIB, MIB, RRC signaling). For example, the base station may configure the UE with the number of PDCCH candidates at each aggregation level L, a monitoring periodicity for a search space, monitoring occasions in symbols within a slot for the search space, a search space type (common search space or UE-specific search space), a combination of DCI format and RNTI to be monitored in the corresponding search space, and an index of a CORESET in which the search space is to be monitored. For example, parameters for the search space for the PDCCH may include the pieces of information as shown in Table 6 below.

TABLE 6
SearchSpace ::= SEQUENCE {

| searchSpaceId SearchSpaceId, | |
|---|---|
| controlResourceSetId ControlResourceSetId | OPTIONAL, -- Cond |

SetupOnly

monitoringSlotPeriodicityAndOffset CHOICE {

sl1 NULL,
sl2 INTEGER (0..1),
sl4 INTEGER (0..3),
sl5 INTEGER (0..4),
sl8 INTEGER (0..7),
sl10 INTEGER (0..9),
sl16 INTEGER (0..15),
sl20 INTEGER (0..19),
sl40 INTEGER (0..39),
sl80 INTEGER (0..79),
sl160 INTEGER (0..159),
sl320 INTEGER (0..319),
sl640 INTEGER (0..639),
sl1280 INTEGER (0..1279),
sl2560 INTEGER (0..2559)

} OPTIONAL, -- Cond Setup
duration INTEGER (2..2559) OPTIONAL, -- Need R
monitoringSymbolsWithinSlot BIT STRING (SIZE (14)) OPTIONAL,

-- Cond Setup

nrofCandidates SEQUENCE {

aggregationLevel1 ENUMERATED {n0, n1, n2, n3, n4, n5, n6, n8},
aggregationLevel2 ENUMERATED {n0, n1, n2, n3, n4, n5, n6, n8},
aggregationLevel4 ENUMERATED {n0, n1, n2, n3, n4, n5, n6, n8},
aggregationLevel8 ENUMERATED {n0, n1, n2, n3, n4, n5, n6, n8},
aggregationLevel16 ENUMERATED {n0, n1, n2, n3, n4, n5, n6, n8}

} OPTIONAL, -- Cond Setup
searchSpace Type CHOICE {

common SEQUENCE {

dci-Format0-0-AndFormat1-0 SEQUENCE {

...

} OPTIONAL, -- Need R
dci-Format2-0 SEQUENCE {

nrofCandidates-SFI SEQUENCE {

aggregationLevel1 ENUMERATED {n1, n2} OPTIONAL, --

Need R

aggregationLevel2 ENUMERATED {n1, n2} OPTIONAL, --

Need R

aggregationLevel4 ENUMERATED {n1, n2} OPTIONAL, --

Need R

aggregationLevel8 ENUMERATED {n1, n2} OPTIONAL, --

Need R

aggregationLevel16 ENUMERATED {n1, n2} OPTIONAL --

Need R

},
...

} OPTIONAL, -- Need R
dci-Format2-1 SEQUENCE {

...

} OPTIONAL, -- Need R
dci-Format2-2 SEQUENCE {

...

} OPTIONAL, -- Need R
dci-Format2-3 SEQUENCE {

dummy1 ENUMERATED {sl1, sl2, sl14, sl15, sl8, sl10, sl16,

s120} OPTIONAL, -- Cond Setup

dummy2 ENUMERATED {n1, n2},
...

} OPTIONAL -- Need R

},
ue-Specific SEQUENCE {

dci-Formats ENUMERATED {formats0-0-And-1-0, formats0-1-

And-1-1},

...,

}

} OPTIONAL -- Cond Setup2

}

The base station may configure the UE with one or plural search space sets according to the configuration information. The base station may configure the UE with search space set 1 and search space set 2. In search space set 1, the UE may be configured to monitor DCI format A scrambled with X-RNTI in the common search space, and in search space set 2, the UE may be configured to monitor DCI format B scrambled with Y-RNTI in the UE-specific search space.

According to the configuration information, one or plural search space sets may be present in the common search space or UE-specific search space. For example, search space set #1 and search space set #2 may be configured as a common search space, and search space set #3 and search space set #4 may be configured as a UE-specific search space.

In the common search space, the UE may monitor, but not limited to, the following combinations of DCI format and RNTI.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI
In the UE-specific search space, the UE may monitor, but not limited to, the following combinations of DCI format and RNTI.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above RNTIs may comply with the following definitions and uses.
Cell RNTI (C-RNTI) is used for scheduling UE-specific PDSCH or PUSCH.
Temporary cell RNTI (TC-RNTI) is used for scheduling UE-specific PDSCH.
Configured scheduling RNTI (CS-RNTI) is used for scheduling semi-statically configured UE-specific PDSCH.
Random access RNTI (RA-RANTI) is used for scheduling PDSCH at random access stage.
Paging RNTI (P-RNTI) is used for scheduling a PDSCH on which paging is transferred.
System information RNTI (SI-RNTI) is used for scheduling a PDSCH on which system information is transferred.
Interruption RNTI (INT-RNTI) is used for notifying whether to puncture a PDSCH.

TPC for PUSCH RNTI (TPC-PUSCH-RNTI) is used for indicating a power control command for PUSCH.

TPC for PUCCH RNTI (TPC-PUCCH-RNTI) is used for indicating a power control command for PUCCH.

TPC for SRS RNTI (TPC-SRS-RNTI) is used for indicating a power control command for SRS.

The DCI formats described above may conform to the definitions shown in Table 7 below.

TABLE 7

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In CORESET p and search space set s, the search space at aggregation level L may be expressed as shown below in Equation (1).

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad ( 1 )$$

L: aggregation level
n_{c1}: carrier index
N_{CCE,p}: total number of CCEs in CORESET p
n^{μ}_{s,f′}: slot index
M^{(L)}_{p,s,max}: number of PDCCH candidates at aggregation level L
m_{snCI}=0, . . . , M^{(L)}_{p,s,max}−1: indexes of PDCCH candidates at aggregation level L
i=0, . . . , L−1
Y_{p,n}_{_{s,f}}_{^{μ}}=(Aₚ·Y_{p,n}_{_{s,f}}_{^{μ}}−1 mod D, Y_{p,-1}=n_{RNTI}≠0, A₀=39827, A₁=39829, A₂=39839, D=65537
N_{RNTI}: UE ID

For the common search space, the value of Y_{p,n}_{_{s,f}}_{^{μ}} may correspond to 0.

For the UE-specific search space, the value of Y_{p,n}_{_{s,f}}_{^{μ}} may correspond to a value that changes depending on the UE ID (ID set to the UE by C-RNTI or base station) and time index.

To support ultra-high-speed data services, the data rate can be increased through spatial multiplexing using multiple transmit and receive antennas. In general, the number of power amplifiers (PA) required increases in proportion to the number of transmit antennas provided in the base station or UE. The maximum output of the base station and UE depends on the power amplifier characteristics, and the maximum output of the base station depends on the size of the cell covered by the base station. Usually, the maximum output is expressed in decibel milliwatts (dBm). The maximum output of the UE is typically 23 dBm or 26 dBm.

As an example of a commercial 5G base station, the base station may be equipped with 64 transmit antennas and corresponding 64 power amplifiers and may operate with a bandwidth of 100 MHz in a frequency band of 3.5 GHz. Consequently, the energy consumption of the base station increases in proportion to the output of the power amplifiers and the operation time of the power amplifiers. Compared to an LTE base station, the 5G base station operating in a relatively high frequency band is characterized by a wider bandwidth and many transmit antennas. While these features have the effect of increasing the data rate, they incur the cost of increased base station energy consumption. Hence, the more base stations constituting a mobile communication network, the greater the energy consumption of the entire mobile communication network in proportion thereto.

As described above, the energy consumption of a base station is greatly influenced by the operation of the power amplifiers. Since the power amplifiers are involved in the base station transmission operation, the downlink (DL) transmission operation of the base station is highly related to the base station's energy consumption. The physical channel and physical signal transmitted by the base station in the downlink are as follows.

(PDSCH indicates a downlink data channel including data to be transmitted to one or multiple UEs.

PDCCH indicates a downlink control channel including scheduling information for PDSCH and PUSCH. Alternatively, the PDCCH alone may transmit control information such as slot format or power control command, without the PDSCH or PUSCH to be scheduled. This scheduling information includes information about resources to which PDSCH or PUSCH is mapped, HARQ-related information, power control information, or the like.

PBCH indicates the downlink broadcast channel that provides the MIB being essential system information required for transmission and reception of data channels and control channels of the UE.

PSS serves as a reference for DL time/frequency synchronization and provides some information about the cell ID.

SSS serves as a reference for DL time and/or frequency (hereinafter referred to as time/frequency) synchronization and provides the remaining information about the cell ID.

Demodulation reference signal (DM-RS) is for UE channel estimation respectively for PDSCH, PDCCH, and PBCH.

CSI reference signal (CSI-RS) is a downlink signal that serves as a reference for measuring the downlink channel state of the UE.

Phase-tracking reference signal (PT-RS) is a downlink signal for phase tracking.

Compared to the downlink transmission operation of the base station, the uplink reception operation of the base station does not account for a large portion of the base station's energy consumption. The physical channel and physical signal received by the base station in the uplink are as follows.

The PUSCH is an uplink data channel including data transmitted by the UE to the base station.

The PUCCH is an uplink control channel that includes control information such as channel state information and HARQ-ACK information transmitted by the UE to the base station.

A physical random access channel (PRACH) is for a random access preamble transmitted by the UE to the base station to perform a random access procedure.

A demodulation reference signal (DM-RS) is for base station's channel estimation respectively for PUSCH and PUCCH.

A PT-RS) is an uplink signal for phase tracking.

A sounding reference signal (SRS) is an uplink signal that serves as a reference for measuring the uplink channel state of the base station.

From a perspective of base station energy saving, if the base station stops downlink transmission operation, the base station energy saving effect may be increased due to the resulting stoppage of power amplifier operation. The operation of not only the power amplifiers but also the remaining base station equipment such as baseband components is reduced, enabling additional energy savings. Similarly, although the uplink reception operation accounts for a relatively small portion of the total energy consumption of the base station, additional energy savings may be achieved if the uplink reception operation can be stopped.

The downlink transmission operation of the base station depends on the amount of downlink traffic. For example, if there is no data to be transmitted to the UE in the downlink, the base station does not need to transmit the PDSCH and the PDCCH for scheduling the PDSCH. Also, if transmission can be temporarily postponed for reasons such as the data is not sensitive to transmission delay, the base station may not transmit the PDSCH or/and PDCCH. For convenience of description below, this method of reducing base station energy consumption by not performing PDSCH and/or PDCCH transmission in relation to data traffic or appropriately adjusting it is referred to as base station energy saving method 1-1.

However, physical channels and physical signals such as PSS, SSS, PBCH, and CSI-RS have the characteristic of being transmitted repeatedly according to an agreed periodicity regardless of data transmission to the UE. Hence, even if the UE does not receive data, the UE may continuously update downlink time/frequency synchronization, downlink channel status, radio link quality, or the like. That is, the PSS, SSS, PBCH, and CSI-RS necessarily require downlink transmission regardless of downlink data traffic, resulting in base station energy consumption. Accordingly, base station energy savings may be achieved by adjusting transmission of the above signals unrelated (or less relevant) to data traffic to infrequently occur (hereinafter referred to as base station energy saving method 1-2).

The energy saving effect of the base station may be maximized by stopping or minimizing the operation of the base station's power amplifiers and the operation of related radio frequency (RF) components and baseband components during the time period when the base station does not perform downlink transmission due to base station energy saving method 1-1 or base station energy saving method 1-2. In the disclosure, the operation of applying an idle time period in base station transmission is referred to as cell DTX. In a similar concept, the operation of applying an idle time period in base station reception is referred to as cell discontinuous reception (cell DRX).

Alternatively, the energy consumption of the base station may be reduced by switching off some of the antennas or power amplifiers of the base station (hereinafter referred to as base station energy saving method 2). In this case, as a reaction to the energy saving effect of the base station, adverse effects such as a decrease in cell coverage or throughput may occur. For example, there may be a base station equipped with 64 transmit antennas and corresponding 64 power amplifiers and operating with a 100 MHz bandwidth in the 3.5 GHz frequency band as described above. If this base station activates only 4 transmit antennas and 4 power amplifiers and switches off the rest for a specific time period for energy savings, the base station energy consumption will be reduced to approximately 1/16 (=4/64) during this time period. However, when activating only 4 transmit antennas and 4 power amplifiers and switching off the rest for a specific time period, due to the decrease in maximum transmission power and beamforming gain, it may be difficult to achieve cell coverage and throughput in the case of 64 antennas and 64 power amplifiers.

Herein, for a distinction from normal base station operation, the base station mode in which operation for base station energy savings is applied is referred to as base station energy saving mode, and the base station mode in which normal base station operation is applied is referred to as base station normal mode (normal mode).

When the base station operates in base station energy saving mode through a method such as cell DTX or cell DRX as described above to reduce energy consumption of the base station, it is necessary to define the corresponding transmission/reception operation of the UE.

When cell DTX is applied, the base station may turn on the transmitter at a specific time to transmit a downlink signal and may turn off the transmitter or simplify transmission processing if there is no signal to be transmitted to the UE for a specific time period, thereby reducing the power consumption of the base station. Cell DTX operation may be controlled based on various parameters and timers.

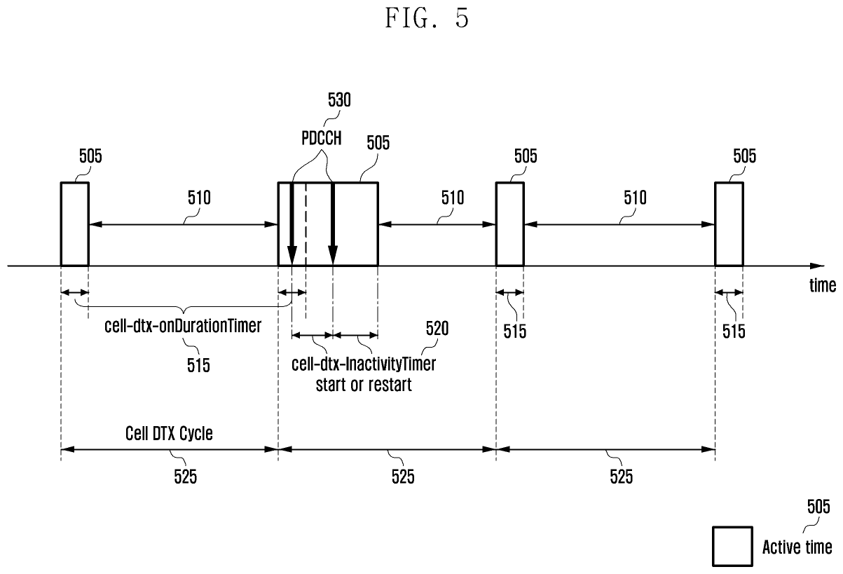

FIG. 5 illustrates an example of Cell DTX operation according to an embodiment.

Referring to FIG. 5, the active time 505 is a time when the base station wakes up every cell DTX cycle 525 to transmit a downlink signal. The downlink signals transmitted by the base station during the active time are the same as those in the existing base station normal mode. The active time 505 may be defined by parameters such as cell-dtx-onDurationTimer, cell-dtx-InactivityTimer, cell-dtx-RetransmissionTimerDL, cell-dtx-RetransmissionTimerUL, and ra-ContentionResolutionTimer. The above parameters are timers having values set by the base station and signaled to the UE and have the function of configuring the base station's downlink signal transmission and the UE's downlink signal reception when specific conditions are satisfied.

A cell-dtx-onDurationTimer 515 is a parameter to set the minimum time for which the base station or UE stays awake during the cell DTX cycle 525. A cell-dtx-InactivityTimer 520 is a parameter for setting an additional time for which the base station or UE stays awake when the base station transmits a PDCCH indicating new uplink data transmission or downlink data transmission (530). A cell-dtx-RetransmissionTimerDL is a parameter to set the maximum time for which the base station or UE stays awake to perform downlink retransmission in a downlink HARQ procedure. A cell-dtx-RetransmissionTimerUL is a parameter to set the maximum time for which the base station or UE stays awake when transmitting an uplink retransmission grant in an uplink HARQ procedure. cell-dtx-onDurationTimer, cell-dtx-InactivityTimer, cell-dtx-RetransmissionTimerDL, and cell-dtx-RetransmissionTimerUL may be set in terms of, for example, time, number of subframes, number of slots, or the like. ra-ContentionResolutionTimer is a parameter for the UE to monitor the PDCCH in a random access procedure.

The inactive time 510 is a time set to turn off the base station transmitter or to simplify base station transmission processing during cell DTX operation, and may be the remaining time excluding the active time 505 from the total time for cell DTX operation. During cell DTX operation, if there is no data traffic to be transmitted from the base station to the UE, the base station may enter the inactive time. That is, during the inactive time, the PDSCH or PDCCH associated with the UE's data traffic does not occur. To simplify base station transmission processing during the inactive time, the transmission of signals such as PSS, SSS, PBCH, CSI-RS, or the like that are unrelated (or less relevant) to data traffic may be adjusted to occur less frequently, thereby achieving base station energy savings. If necessary, transmission of PSS, SSS, PBCH, and CSI-RS may be stopped during the inactive time.

If there is no signal to be transmitted from the base station to the UE during the active time 505, the base station may enter a sleep or inactive state to reduce base station power consumption. Similarly, if the UE does not receive a PDCCH from the base station during the active time 505, the UE may enter a sleep or inactive state to reduce UE power consumption.

The cell DTX cycle 525 refers to the periodicity in which the base station wakes up to perform normal downlink signal transmission. As described above, during the cell DTX cycle, the active time and the inactive time alternate. During cell DTX operation, the base station restarts the cell-dtx-onDurationTimer 515 when the cell DTX cycle 525 has elapsed from the start point (e.g., start symbol) of the cell-dtx-onDurationTimer 515. When operating with the cell DTX cycle 525, the base station may start the cell-dtx-onDurationTimer 515 in a slot after cell-dtx-SlotOffset at a subframe satisfying Equation (2) below, where cell-dtx-SlotOffset refers to the delay before starting the cell-dtx-onDuration Timer 515. The cell-dtx-SlotOffset may be set in terms of time or number of slots, for example.

[(SFN X 10)+subframe number] modulo (cell-dtx-Cycle)=cell-dtx-StartOffset (2)

At this time, cell-dtx-Cycle and cell-dtx-StartOffset may be used to define the subframe at which the cell DTX cycle 525 starts. The cell-dtx-Cycle and cell-dtx-CycleStartOffset may be set in terms of time, number of subframes, or number of slots, and may be notified by the base station to the UE through signaling.

FIG. 5 is described from the perspective of the cell DTX of the base station, but may be applied to cell DRX operation of the base station by replacing base station transmission operation in the above description with base station reception operation. The base station may operate cell DTX operation and cell DRX operation independently or in combination.

As described above, if the base station stops transmitting a reference signal such as SSB or CSI-RS or transmits them less frequently than in the base station normal mode, for the inactive time during cell DTX operation, this may have a negative impact on the reception performance of the UE that determines radio link quality by referring to the above reference signal.

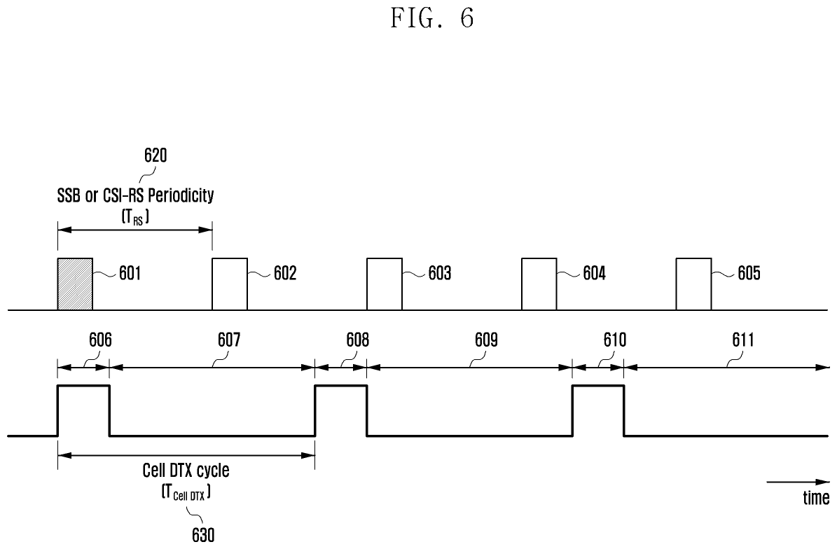

FIG. 6 illustrates an example of Cell DTX operation and reference signal transmission according to an embodiment.

Referring to FIG. 6, in the base station normal mode, the SSB or CSI-RS is transmitted with a transmission periodicity TRS 620. FIG. 6 illustrates when a cell DTX cycle 630 is in operation to save base station power and the cell DTX cycle is given by Tcell DTx 630. The active time is indicated by 606, 608, or 610, and the inactive time is indicated by 607, 609 or 611. If the base station stops transmitting downlink reference signals including the SSB and CSI-RS during the inactive time to maximize the base station power saving effect, the base station may transmit an SSB or CSI-RS only at time 601, which overlaps in time with the active time 606, and may not transmit an SSB or CSI-RS at the remaining time 602, 603, 604, or 605, which overlaps in time with the inactive time 607, 609, or 611. As a result, from the UE's perspective, there is a shortage of reference signal samples to be used for measuring the radio link quality between the UE and the base station, which causes a decrease in the accuracy of radio link quality measurement results of the UE.

To solve the above problem, disclosed herein is a method for the UE to receive downlink signals when the base station operates in base station energy saving mode using cell DTX referring to the following embodiments.

### First Embodiment

The first embodiment describes a method of adjusting the transmission periodicity of a reference signal, and the cell DTX cycle or cell DRX cycle, when the base station operates in base station energy saving mode using cell DTX.

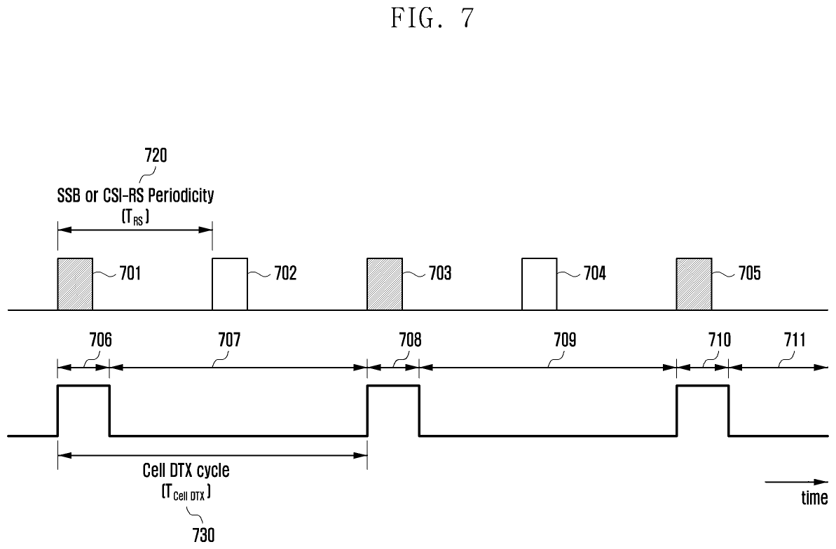

FIG. 7 illustrates an example of a method for measuring a reference signal in a UE during Cell DTX operation according to an embodiment.

Referring to FIG. 7, the base station adjusts the cell DTX cycle so that the transmission time of a reference signal such as SSB or CSI-RS overlaps in time with the active time as much as possible. For example, in FIG. 7, among transmission times 701, 702, 703, 704, and 705 for reference signals, transmission times 701, 703 and 705 overlap respectively with active times 706, 708, and 710, so that the base station may transmit a reference signal to the UE at transmission times 701, 703, and 705. For this operation, the base station may set the cell DTX cycle (TCell DTX) 730 and the transmission periodicity (TRS) 720 of the reference signal to satisfy Equation (3) below.

T_{Cell DTX}=N×TRS (3)

In Equation (3), N is a positive integer. The base station may adjust the gap (T_{gap}) between the cell DTX cycle and the start time of the transmission periodicity for the reference signal so that the transmission of a reference signal overlaps with the active time. FIG. 7 represents an example where N=2 and T_{gap}=0, but this is for illustration purposes only and does not limit the scope of the disclosure. T_{gap} may be expressed in units of symbols, slots, ms, or the like. The base station may notify N and T_{gap} to the UE through signaling.

### Second Embodiment

The second embodiment describes a method of adjusting transmission of a reference signal by setting the transmission periodicity for the reference signal in multiple stages, when the base station operates in base station energy saving mode using cell DTX.

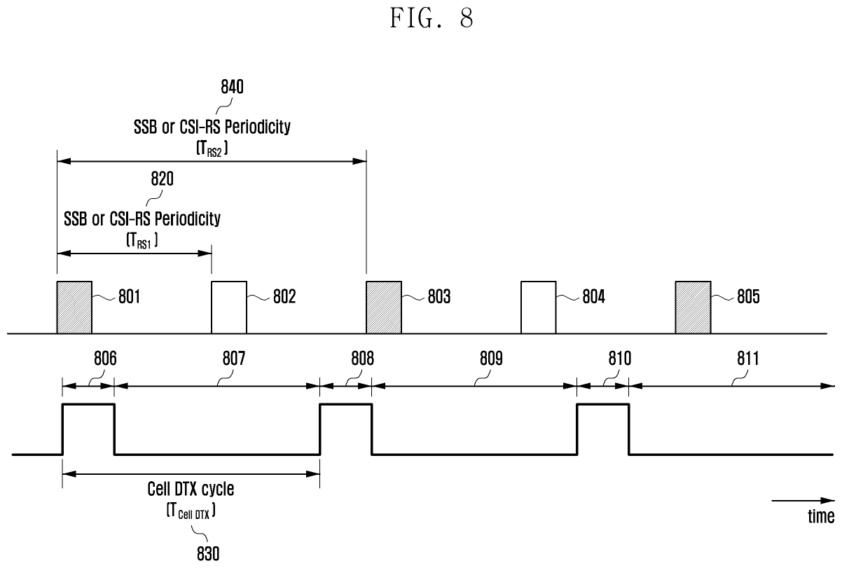

FIG. 8 illustrates another example of a method for measuring a reference signal in a UE during Cell DTX operation according to an embodiment. Referring to FIG. 8, when the base station operates in base station normal mode, the base station may set the transmission periodicity of the reference signal to _{TRS1} (820), and when the base station operates in base station energy saving mode based on cell DTX, the base station may set the transmission periodicity of the reference signal to T_{RS2} (840) (T_{RS2}>T_{RS1}). Additionally, when cell DTX is in operation, the reference signal having its transmission periodicity adjusted to T_{RS2} is allowed to be transmitted even if it does not overlap with the active time, thereby supporting measurement operation of the UE for the reference signal. That is, the reference signal whose transmission periodicity is adjusted to T_{RS2} may be transmitted even during the inactive time. In FIG. 8, the base station adjusts the transmission periodicity of a reference signal based on T_{RS2} during cell DTX operation, so that the reference signal may be transmitted at times 801, 803 and 805. The base station may notify the UE of the above T_{RS2} configuration information through signaling. Alternatively, cell DTX operation may be controlled by mutual agreement between the UE and the base station so that the relationship T_{RS2}=K×T_{RS1} (K is a positive integer) is held.

As a variant of the second embodiment, it is possible to make a certain level of compromise between base station power saving and UE reception performance by using a scheme that allows transmission of a reference signal during the inactive time of cell DTX operation but does not allow transmission of a PDCCH or PDSCH associated with data traffic other than the reference signal.

### Third Embodiment

The third embodiment describes a method for the UE to measure radio link quality when the base station operates in base station energy saving mode using cell DTX.

The UE measures the reference signal received during a specific time period (Tₑᵥₐₗᵤₐₜₑ) to determine the radio link quality. When the base station operates in cell DTX, the number of samples for the reference signal that the UE will receive may be insufficient compared to operation in the base station normal mode. So, the number of samples for the reference signal may be secured by adjusting Tₑᵥₐₗᵤₐₜₑ in proportion to the cell DTX cycle. Table 8 below shows an example where Tₑᵥₐₗᵤₐₜₑ, which is the time period during which the UE measures the reference signal, increases as the cell DTX cycle value increases.

TABLE 8

| Configuration | T_{Evaluate} |
|---|---|
| no Cell DTX | Y0 |
| Cell DTX cycle ≤ X1 | Y1 |
| X1 < Cell DTX cycle ≤ X2 | Y2 |
| . . . | . . . |

Note:
X1 < X2, Y0 < Y1 < Y2

The time units of X1, X2, Y0, Y1, and Y2 may be symbols, slots, subframes, ms, or the like, and the base station may notify these units to the UE through signaling or may use fixed values agreed upon in advance.

The third embodiment may be applied in combination with the first embodiment and the second embodiment.

### Fourth Embodiment

The fourth embodiment describes examples of a UE procedure and a base station procedure and may be performed in combination with at least one of the first to third embodiments.

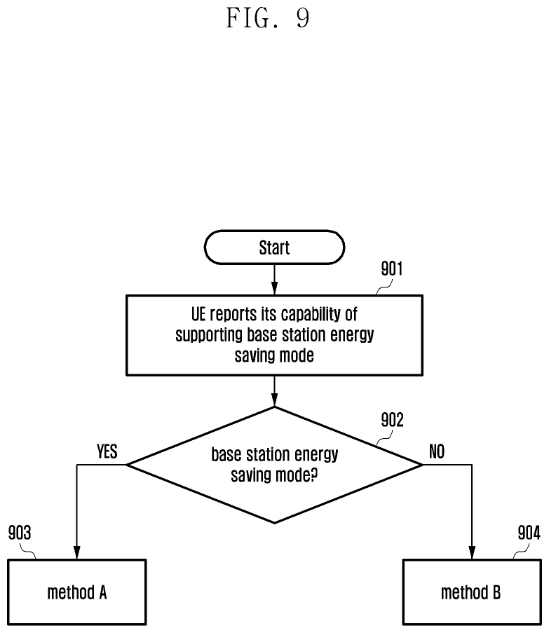

FIG. 9 illustrates a UE procedure according to an embodiment.

Referring to FIG. 9, a procedure is shown for the UE to determine the transmission time of a reference signal depending on whether the base station operates in base station normal mode or base station energy saving mode.

In step 901, the UE reports UE capability information including a capability to support the base station energy saving mode to the base station. Specifically, the UE capability information may include at least one piece of capability information related to the base station energy saving mode such as information indicating whether the UE supports the base station energy saving mode, control information related to the frequency band supported by the UE, and control information related to the channel bandwidth supported by the UE.

In step 902, the UE determines whether the base station is operating in the base station energy saving mode. The base station may notify the UE through signaling whether it is operating in the base station energy saving mode or the base station normal mode.

In step 903, if the base station is operating in the base station energy saving mode, the UE may perform reference signal measurement for determining the radio link quality according to the first to third embodiments described above (method A). For example, the cell DTX cycle may be adjusted so that the transmission time of the reference signal overlaps in time with the active time according to the first embodiment, and the UE may perform reference signal measurement accordingly. As another example, when the base station operates in the energy saving mode, the transmission periodicity T_{RS2} (T_{RS2}>T_{RS1}) for the reference signal may be set according to the second embodiment, and the UE may perform reference signal measurement accordingly. As another example, the time period Tₑᵥₐₗᵤₐₜₑ for performing reference signal measurement may be adjusted in correspondence to the cell DTX cycle according to the third embodiment, and the UE may perform reference signal measurement accordingly.

In step 904, if the base station is operating in the base station normal mode, and not in the base station energy saving mode, the UE may perform reference signal measurement for determining the radio link quality in the existing manner (method B). For example, the UE may receive a reference signal to perform reference signal measurement according to the transmission periodicity T_{RS1} for the reference signal set for the base station normal mode.

The method may be performed even when steps described in FIG. 9 are changed in order, or new steps are added.

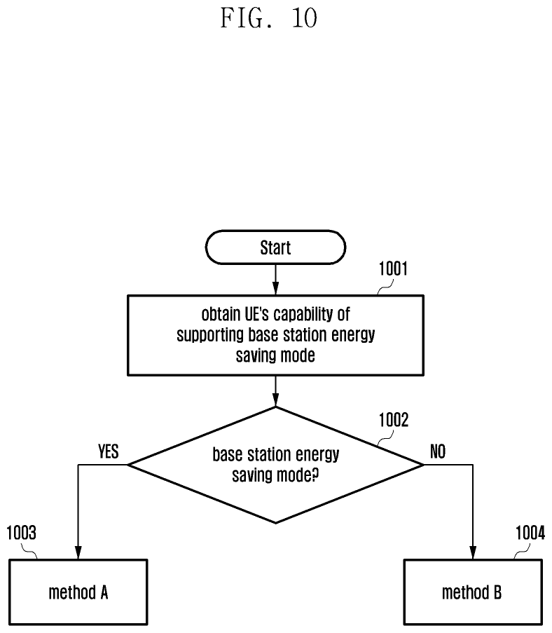

FIG. 10 illustrates a base station procedure according to an embodiment.

Referring to FIG. 10, in step 1001, the base station acquires UE capability information including a capability to support base station energy saving mode from the UE. Specifically, the UE capability information may include at least one piece of capability information related to base station energy saving mode such as information indicating whether the UE supports base station energy saving mode, control information related to the frequency band supported by the UE, and control information related to the channel bandwidth supported by the UE.

In step 1002, the base station may determine whether to operate in the base station energy saving mode or the base station normal mode based on the UE capabilities, and notify the determination to the UE through signaling. Information that can be included in response to a change in the base station mode may be configured in advance by the base station to the UE through signaling.

In step 1003, if the base station has notified through signaling to the UE that it is operating in the base station energy saving mode, the base station may recognize that the UE has performed reference signal measurement for determining the radio link quality in correspondence to the base station energy saving mode according to the first to third embodiments described above (method A), and consider this in subsequent scheduling. For example, the base station may recognize that the cell DTX cycle has been adjusted so that the transmission time of the reference signal overlaps in time with the active time according to the first embodiment, and the UE has performed reference signal measurement accordingly, and may consider this in subsequent scheduling. As another example, the base station may recognize that the transmission periodicity T_{RS2} (T_{RS2}>T_{RS1}) of the reference signal has been set for the base station energy saving mode according to the second embodiment, and the UE has performed reference signal measurement accordingly, and may consider this in subsequent scheduling. As another example, the base station may recognize that the time period Tₑᵥₐₗᵤₐₜₑ for performing reference signal measurement during the cell DTX cycle has been adjusted according to the third embodiment, and the UE has performed reference signal measurement accordingly, and may consider this in subsequent scheduling.

If the base station has notified through signaling to the UE that it is operating in base station normal mode, in step 1004, the base station may recognize that the UE has performed reference signal measurement for determining the radio link quality in correspondence to base station normal mode (method B) and consider this in subsequent scheduling. For example, the base station may recognize that the UE has received the reference signal and performed reference signal measurement according to the transmission periodicity T_{RS1} of the reference signal set for the base station normal mode and may consider this in subsequent scheduling.

The disclosure may be performed even when steps described in FIG. 10 are changed in order, or new steps are added.

Within a cell managed by the base station operating as described above, a UE (UE A) that supports UE operation according to the base station energy saving mode and a UE (UE B) that does not support the UE operation according to the base station energy saving mode may coexist. UE A may perform UE operations according to the first to fourth embodiments described above. However, UE B cannot respond to a change in the base station transmission scheme according to the base station energy saving mode, so there is a concern about performance degradation in transmission efficiency, cell capacity, throughput, UE power consumption, or the like. Hence, if the base station can distinguish between UE A and UE B by referring to the UE capability reports, additional actions may be taken to prevent performance degradation of UE B. For example, the base station may handover UE B to a neighbor cell managed by a base station operating in the base station normal mode other than the current cell that will be switched to the base station energy saving mode.

The fourth embodiment may have many different variations. For example, it is possible to omit the step in which the UE reports UE capabilities to the base station. The base station energy saving mode according to the fourth embodiment may include not only operations for cell DTX or cell DRX but also operations for changing base station antennas or power amplifiers.

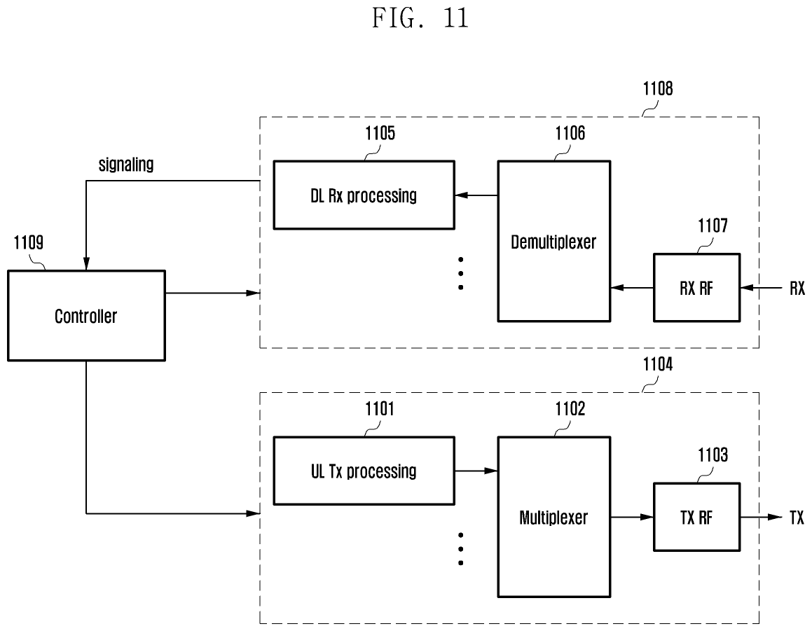

FIG. 11 illustrates the transceiver of a UE in a wireless communication system according to an embodiment.

Referring to FIG. 11, the UE may be composed of a transmitter 1104 including an uplink transmission processing block 1101, a multiplexer 1102, and a transmission RF block 1103, a receiver 1108 including a downlink reception processing block 1105, a demultiplexer 1106, and a reception RF block 1107, and a controller 1109. The controller 1109 may control individual component blocks of the receiver 1108 for receiving a data channel or control channel transmitted by the base station as described above, and individual component blocks of the transmitter 1104 for transmitting uplink signals.

In the transmitter 1104 of the UE, the uplink transmission processing block 1101 may generate a signal to be transmitted by performing processes such as channel coding and modulation. The signal generated in the uplink transmission processing block 1101 may be multiplexed with other uplink signals by the multiplexer 1102, signal-processed in the transmission RF block 1103, and then transmitted to the base station.

The receiver 1108 of the UE demultiplexes a signal received from the base station and distributes the demultiplexing result to individual downlink reception processing blocks. The downlink reception processing block 1105 may perform processes such as demodulation and channel decoding on the downlink signal of the base station to obtain control information or data transmitted by the base station. The receiver 1108 of the UE may support the operation of the controller 1109 by applying the output result of the downlink reception processing block to the controller 1109.

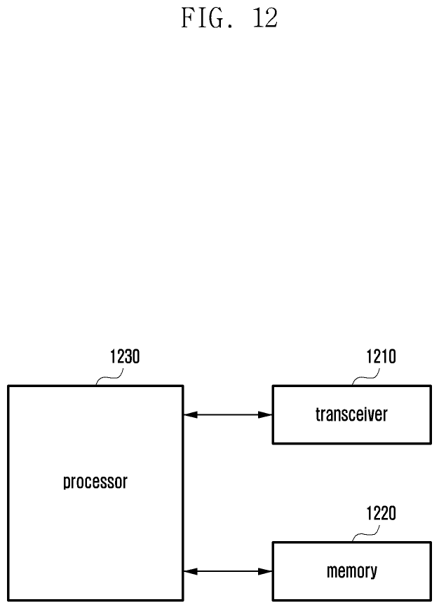

FIG. 12 illustrates the structure of a UE according to an embodiment.

Referring to FIG. 12, the UE may include a processor 1230, a transceiver 1210, and a memory 1220. However, the components of the UE are not limited to those described above. For example, the UE may include more or fewer components than the above-described components. The processor 1230, transceiver 1210, and memory 1220 may be implemented in the form of a single chip. According to an embodiment, the transceiver 1210 in FIG. 12 may include the transmitter 1104 and receiver 1108 in FIG. 11. Additionally, the processor 1230 in FIG. 12 may include the controller 1109 in FIG. 11.

The processor 1230 may control a series of processes in which the UE can operate according to the above-described embodiments. For example, the processor 1230 may control components of the UE to perform reference signal measurements for determining the radio link quality of the UE. The processor 1230 may be configured as one or multiple instances, and the processor 1230 may execute programs stored in the memory 1220 to perform UE transmission and reception in a wireless communication system applying operations of the disclosure.

The transceiver 1210 may transmit and receive signals to and from a base station. The signals transmitted and received to and from a base station may include control information, and data. The transceiver 1210 may be composed of an RF transmitter that up-converts the frequency of a signal to be transmitted and amplifies the signal, and an RF receiver that low-noise amplifies a received signal and down-converts the frequency thereof. However, this is only an embodiment of the transceiver 1210, and the components of the transceiver 1210 are not limited to the RF transmitter and RF receiver. Additionally, the transceiver 1210 may receive a signal through a radio channel and output it to the processor 1230 and may transmit a signal output from the processor 1230 through a radio channel.

The memory 1220 may store programs and data necessary for the operation of the UE and control information or data included in signals transmitted and received by the UE. The memory 1220 may be composed of a storage medium such as read only memory (ROM), random access memory (RAM), a hard disk, compact disc (CD)-ROM, and a digital versatile disc (DVD), or a combination of storage media. The memory 1220 may be configured as multiple instances and may store programs for performing reference signal measurement for determining the radio link quality of the UE, as described herein.

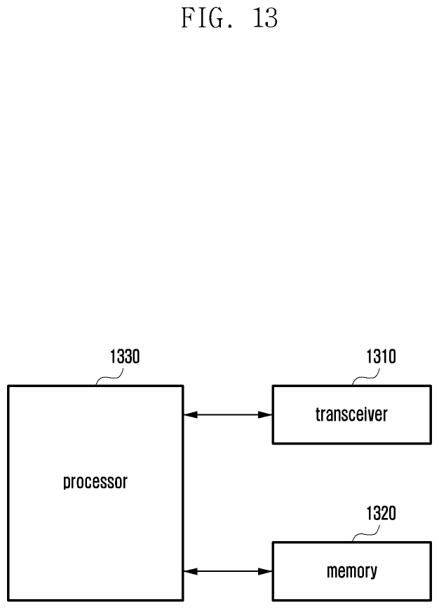

FIG. 13 illustrates the structure of a base station according to an embodiment.

Referring to FIG. 13, the base station may include a processor 1330, a transceiver 1310, and a memory 1320. However, the components of the base station are not limited to those described above. For example, the base station may include more or fewer components than the above-described components. The processor 1330, transceiver 1310, and memory 1320 may be implemented in the form of a single chip.

The processor 1330 may control a series of processes so that the base station can operate according to the embodiments herein. For example, the processor 1330 may control components of the base station to perform the method of scheduling a UE based on reference signal measurement for determining the radio link quality of the UE to an embodiment The processor 1330 may be configured as one or multiple instances, and the processor 1330 may perform the method of the disclosure described above for scheduling a UE according to a channel state measurement reporting request to the UE by executing programs stored in the memory 1320.

The transceiver 1310 may transmit and receive signals to and from a UE. The signals transmitted and received to and from a UE may include control information, and data. The transceiver 1310 may be composed of an RF transmitter that up-converts the frequency of a signal to be transmitted and amplifies the signal, and an RF receiver that low-noise amplifies a received signal and down-converts the frequency thereof. However, this is only an embodiment of the transceiver 1310, and the components of the transceiver 1310 are not limited to the RF transmitter and RF receiver. Additionally, the transceiver 1310 may receive a signal through a radio channel and output it to the processor 1330 and may transmit a signal output from the processor 1330 through a radio channel.

The memory 1320 may store programs and data necessary for the operation of the base station. Additionally, the memory 1320 may store control information or data included in signals transmitted and received by the base station. The memory 1320 may be composed of a storage medium such as ROM, RAM, a hard disk, CD-ROM, a DVD, or a combination of storage media. The memory 1320 may be configured as multiple instances and may store programs for performing the method of scheduling a UE based on reference signal measurement for determining the radio link quality of the UE.

It will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a particular manner, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Additionally, each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit”, “module”, or the like used in the embodiments may refer to a software component or a hardware component such as an FPGA or ASIC capable of carrying out a function or an operation. However, “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of fewer components and units, and may be combined with others to compose more components and units. Components and units may be implemented to drive one or more central processing units (CPUs) in a device or a secure multimedia card. Also, in embodiments, a unit or the like may include one or more processors.

The methods of the disclosure may be implemented in the form of hardware, software, or a combination thereof.

When implemented in software, a computer-readable storage medium storing one or more programs (software modules) may be provided. The one or more programs stored in the computer-readable storage medium are configured to be executable by one or more processors of an electronic device and include instructions that cause the electronic device to execute the methods according to the embodiments described herein.

Such a program (software module, software) may be stored in at least one of RAM, a nonvolatile memory such as a flash memory, a ROM, an electrically erasable programmable read only memory (EEPROM), a magnetic disc storage device, a CD-ROM, a DVD, other types of optical storage devices, or a magnetic cassette.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that carries out an embodiment of the disclosure through an external port. In addition, a separate storage device on a communication network may access the device that executes an embodiment of the disclosure.

Meanwhile, the embodiments of the disclosure disclosed in the present specification and drawings are provided as specific examples to easily explain the technical contents of the disclosure and help understanding of the disclosure, and are not intended to limit the scope of the disclosure. Although specific terms have been used, they are used only in a general sense of easily describing the technical content of the disclosure and aiding in the understanding of the disclosure, and are not intended to limit the scope of the disclosure.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a communication system, the method comprising:
transmitting, to a base station, capability information including a capability to support an energy saving mode of the base station, the energy saving mode of the base station being based on cell discontinuous transmission (DTX);
receiving, from the base station, information associated with a measurement for the energy saving mode of the base station;
identifying that the base station operates according to the energy saving mode; and
receiving, from the base station, a reference signal for measurement based on the information.

2. The method of claim 1,
wherein the information includes a cell DTX cycle and a gap between the cell DTX cycle and a start of a periodicity of the reference signal, and
wherein the reference signal is received in an active time of the cell DTX defined based on the cell DTX cycle and the gap between the cell DTX cycle.

3. The method of claim 2,
wherein the cell DTX cycle is a multiple of the periodicity of the reference signal.

4. The method of claim 1,
wherein the information includes a first periodicity for the energy saving mode, and
wherein the reference signal is received based on the first periodicity for the energy saving mode.

5. The method of claim 4,
wherein the first periodicity for the energy saving mode is larger than a second periodicity for a normal mode.

6. A method performed by a base station operating according to an energy saving mode in a communication system, the method comprising:
receiving, from a user equipment (UE), capability information including a capability to support the energy saving mode of the base station, the energy saving mode of the base station being based on cell discontinuous transmission (DTX);
transmitting, to the UE, information associated with a measurement for the energy saving mode of the base station; and
transmitting, to the UE, a reference signal for measurement according to the information.

7. The method of claim 6,
wherein the information includes a cell DTX cycle and a gap between the cell DTX cycle and a start of a periodicity of the reference signal, and
wherein the reference signal is transmitted in an active time of the cell DTX defined based on the cell DTX cycle and the gap between the cell DTX cycle.

8. The method of claim 7,
wherein the cell DTX cycle is a multiple of the periodicity of the reference signal.

9. The method of claim 6,
wherein the information includes a first periodicity for the energy saving mode, and
wherein the reference signal is transmitted based on the first periodicity for the energy saving mode.

10. The method of claim 9,
wherein the first periodicity for the energy saving mode is larger than a second periodicity for a normal mode.

11. A user equipment (UE) in a communication system, the UE comprising:
a transceiver; and
at least one processor configured to:
transmit, to a base station, capability information including a capability to support an energy saving mode of the base station, the energy saving mode of the base station being based on cell discontinuous transmission (DTX),
receive, from the base station, information associated with a measurement for the energy saving mode of the base station,
identify that the base station operates according to the energy saving mode, and
receive, from the base station, a reference signal for measurement based on the information.

12. The UE of claim 11,
wherein the information includes a cell DTX cycle and a gap between the cell DTX cycle and a start of a periodicity of the reference signal, and
wherein the reference signal is received in an active time of the cell DTX defined based on the cell DTX cycle and the gap between the cell DTX cycle.

13. The UE of claim 12,
wherein the cell DTX cycle is a multiple of the periodicity of the reference signal.

14. The UE of claim 11,
wherein the information includes a first periodicity for the energy saving mode, and
wherein the reference signal is received based on the first periodicity for the energy saving mode.

15. The UE of claim 14,
wherein the first periodicity for the energy saving mode is larger than a second periodicity for a normal mode.

16. A base station operating according to an energy saving mode in a communication system, the base station comprising:
a transceiver; and
at least one processor configured to:
receive, from a user equipment (UE), capability information including a capability to support the energy saving mode of the base station, the energy saving mode of the base station being based on cell discontinuous transmission (DTX),
transmit, to the UE, information associated with a measurement for the energy saving mode of the base station, and
transmit, to the UE, a reference signal for measurement according to the information.

17. The base station of claim 16,
wherein the information includes a cell DTX cycle and a gap between the cell DTX cycle and a start of a periodicity of the reference signal, and
wherein the reference signal is transmitted in an active time of the cell DTX defined based on the cell DTX cycle and the gap between the cell DTX cycle.

18. The base station of claim 17,
wherein the cell DTX cycle is a multiple of the periodicity of the reference signal.

19. The base station of claim 16,
wherein the information includes a first periodicity for the energy saving mode, and
wherein the reference signal is transmitted based on the first periodicity for the energy saving mode.

20. The base station of claim 19,
wherein the first periodicity for the energy saving mode is larger than a second periodicity for a normal mode.
